(19) United States
(12) Patent Application Publication
(10) Pub. No.: US 2004/0084787 A1
(43) Pub. Date: May 6, 2004

(54) Humidifier bottle latch carry handle

(75) Inventors: Matthew Williams, Bridgeton, MO (US); Steven Rhea, St. Peters, MO (US); John Garner, O'Fallon, MO (US)

Correspondence Address: HOWREY SIMON ARNOLD & WHITE LLP, ATTEN. DOCKETING DEPT. (A), 750 BERING DRIVE, HOUSTON, TX, 77057, US

(73) Assignee: Emerson Electric Co., St. Louis, MO

(21) Appl. No.: 10/065,638

(22) Filed: Nov. 5, 2002

(51) Int. Cl. B01F 3/04

(52) U.S. Cl. 261/72.1

(57) ABSTRACT

A bottle fill humidifier includes a humidification housing removably positioned on a water reservoir base. At least one water bottle is mounted to the base. In order to facilitate an easier and faster means of replacing the humidifier filter and maintain the rigidity of the humidifier, a latch is provided to secure the housing to the base via the mounted bottle.

### BACKGROUND OF INVENTION

1. Field of the Invention

The present invention relates generally to humidifiers, and more specifically, to a latch for fastening a removable humidification housing to a mounted water bottle thereby maintaining the rigidity of the humidifier during lifting and carrying.

2. Description of Related Art

Humidifiers are well known and commonly used in households and businesses to add moisture to indoor air providing a more comfortable living environment. A comfortable level of humidity is generally 30-50% in the winter and 40-50% in the summer. If the humidity level is lower, atopic dermatitis, excessive static electricity, drying out of furniture and other various concerns may occur. A humidifier's many advantages include: alleviating a cold sufferer's sore throat, reducing any difficulty in breathing, and generally improving the health and comfort of the user's home.

Several varieties of humidifiers exist, differing in both humidification methods, size and refilling. The method of humidification varies from evaporative, ultrasonic, cool mist impeller, steam vaporizers and warm mist humidifiers. The present invention is directed to an evaporative humidifier, which is often called a wicking humidifier because is employs a large wick or filter. The wick or filter draws water upward from a water reservoir base through capillary action. A fan blows air across or through the filter thereby diffusing moisture throughout the room.

The varying sizes include table top, console and central humidifiers. While tabletop designs typically humidify one room, console and central humidifiers may humidify multiple rooms or an entire house. Table top and console humidifiers require manual filling of the water while central humidifiers connect directly to the water pipeline of the house. The humidifier of the present invention is generally directed to a console humidifier, but has application to a tabletop design as well.

Refilling a humidifier generally varies between a bottle fill design and a bucket fill design. Bottle fill designs have removable bottles for supplying the humidification humidifier with water. This enables the user to transport the bottle individually to the nearest sink for refilling. The reasonable size of the bottle and its removability from the humidifier make it easy to transport and causes little mess. In a bucket fill design, however, a standard bucket or pitcher must be used to carry water from the sink to refill the humidifier as needed. Although the user may transport varying amounts of water depending on the strength of the user, the bucket fill design may require several trips and cause excessive spillage. The present invention is directed to a bottle fill humidifier.

One common goal of both console and tabletop models is to provide a simple means to lift and carry the humidifier. Such a design is found in U.S. Pat. No. 5,480,588 issued in the name of Tomasiak (Tomasiak) and incorporated herein by reference in its entirety. Among other things, the disclosure of the Tomasiak patent provides for a water reservoir base with a centrally located humidification housing and two spaced water bottles mounted to opposing end portions of the base. An integrally molded handle is provided at the upper ends of each bottle for lifting and carrying of the humidifier. Each handle has an elongated opening formed on the underside of the handle so that a user's fingers may comfortably grasp the handle and transport the humidifier.

Humidifier filters generally need replacing once a season because they gather impurities leading to discoloration of the filter. Once the filter becomes distinctly discolored, a replacement is necessary. In some prior art humidifiers, a screwdriver or other implement must be used to pry open a grill covering the filter. After the filter is replaced, the grill must be realigned and remounted to the humidifier. Placing the humidification housing on the base where a user only lifts it straight up to remove provides a simple means for accessing and replacing the filter. As fewer parts are involved and no implements must be used, reliability and efficiency is increased. However, which such a design, when transporting the humidifier the housing becomes unstable and may separate from the base.

Thus, there is a need for a simple means of accessing and replacing the filter while still maintaining the rigidity of the humidifier. The present invention addresses associated shortcomings in the prior art.

### SUMMARY OF INVENTION

In accordance with aspects of the present invention, a humidifier includes a water reservoir base, a humidification housing removably positioned on the base, at least one water bottle for dispensing water into the base, and a latch for fastening the housing to the bottle thereby securing the housing to the base by means of the mounted bottle. The latch may be connected to the housing or the bottles. In some embodiments, the bottle includes a handle at an upper end of the bottle. The latch may be pivotally attached to the housing and pivot to fasten the housing to the bottle. Further, the latch may adjoin to the underside of the bottle handle in the fastened position. In other embodiments, the latch is mounted on the bottle and fastens to a raised edge defined by the housing. The bottle may be removably mounted to the base, for example, via prongs extending from the bottle that is arranged to be received by corresponding tangs defined by the base.

### BRIEF DESCRIPTION OF DRAWINGS

Other objects and advantages of the invention will become apparent upon reading the following detailed description and upon reference to the drawings in which:

FIG. 1 illustrates a perspective view of a bottle fill humidifier in accordance with an exemplary embodiment of the present invention.

FIG. 2 is a partial view of the bottom portion of a humidifier bottle in accordance with aspects of the present invention.

FIG. 3 is a sectional view of a portion of a humidifier in accordance with the present invention, illustrating an exemplary arrangement for mounting the bottle to the humidifier base.

FIG. 4 illustrates a partial perspective view of a bottle latch in accordance with the exemplary embodiment of the present invention.

FIG. 5 is a cross-sectional view of the bottle latch shown in FIG. 4.

FIG. 6 is a cross-sectional view of a bottle latch in accordance with an alternative embodiment of the present invention.

FIG. 7 illustrates a partial perspective view of a humidifier incorporating the bottle latch as shown in FIG. 6.

FIG. 8 is a cross-sectional view of a bottle latch in accordance with another alternative embodiment of the present invention.

FIG. 9 illustrates a partial perspective view of a humidifier incorporating the bottle latch as shown in FIG. 8.

FIG. 10 is a cross-sectional view of a fastening means in accordance with an alternative embodiment of the present invention.

FIG. 11 illustrates a partial perspective view of a humidifier incorporating the fastening means as shown in FIG. 10 in accordance with an alternative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

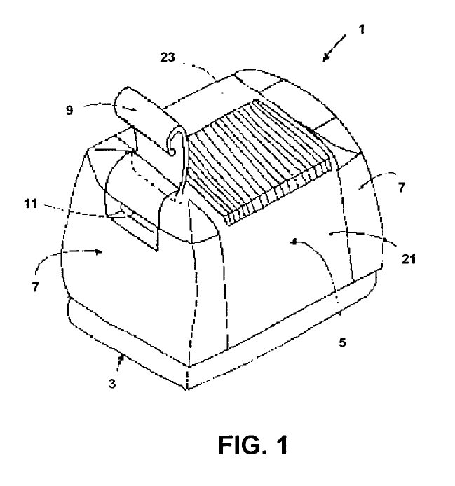

Turning to the figures, and in particular FIG. 1, an exemplary humidifier in accordance with aspects of the present invention is illustrated. A removable humidification housing 5 sits on top of a water reservoir base 3. A water bottle 7 is mounted to the base 3. In the embodiment illustrated in FIG. 1, two bottles 7 are positioned adjacent to and on opposing sides of the housing 5.

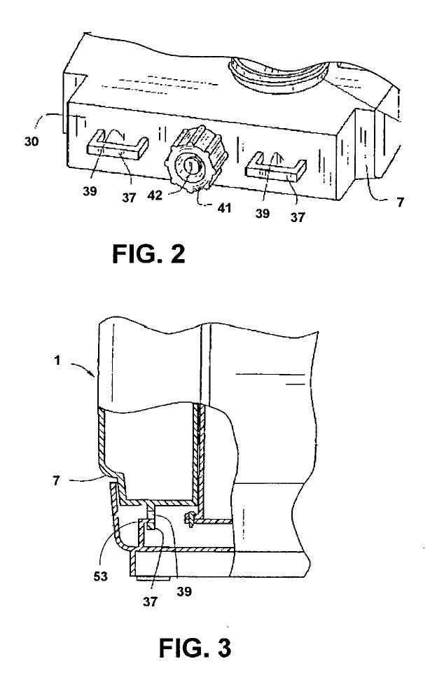

The water bottles 7 may be mounted to the base 3 in the manner disclosed in the incorporated Tomasiak patent, U.S. Pat. No. 5,480,588. FIG. 2 illustrates the lower part 30 of the humidifier bottle 7. The bottle 7 includes a water dispensing cap 41 having a dispensing valve 42. The bottles 7 are received by the base 3 for providing water thereto via the valve 42, while at the same time the bottles 7 provide lifting and carrying elements for the humidifier 1. To this end, spaced depending prongs 37 extend from the bottom of the bottle 7 and corresponding tangs 53 are received within an openings 39 of the depending prongs 37 as shown in FIG. 3.

The housing 5 comprises an upwardly extending sidewall 21 that supports a top portion 23 as shown, for example, in FIG. 1. The user may remove the housing 5 to easily access the filter (not shown) by first unfastening a latch 9 thereby allowing access to the bottles 7. The bottles 7 may be removed by tilting them away from the housing 5 to disengage the prongs 37 from the tang 53 and then lifting the bottle 7 up. Once the bottles 7 have been removed, the user can lift the housing 5 straight up to clear the filter (not shown).

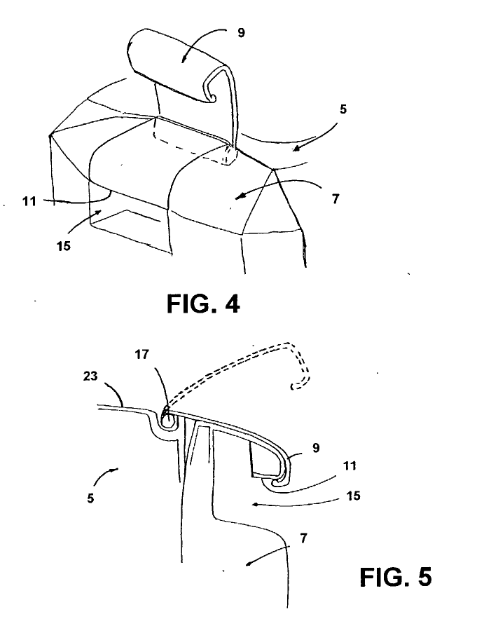

In the exemplary embodiment shown in FIG. 1, the latch 9 is mounted to the top portion 23 of the housing 5 as is further shown in FIGS. 4-5. In the fastened position, the latch 9 may pivot around a fulcrum 17 to fasten to the bottle 7. The bottle 7 may further include a handle 11 situated at an upper end of the bottle 7. This handle 11 forms a depression 15 on the under side of the handle 11 thus allowing the user to comfortably fit his/her fingers inside for lifting and carrying the bottle 7 when separated from the humidifier 1, such as for refilling with water, or for carrying the humidifier 1 when the bottles 7 are mounted in the base 3. In the fastened position the latch 9 pivots towards the bottle 7 and resiliently flexes around the handle 11. The latch 9 may further adjoin with at least a portion of the underside of the handle 111 thereby allowing adequate space for the user's fingers to fit within the depression 15. Additionally, in the exemplary embodiment the latch 9 may pivot upwards and away from the bottle 7 in the unfastened position. This allows the user to freely access the bottle 7 for removal.

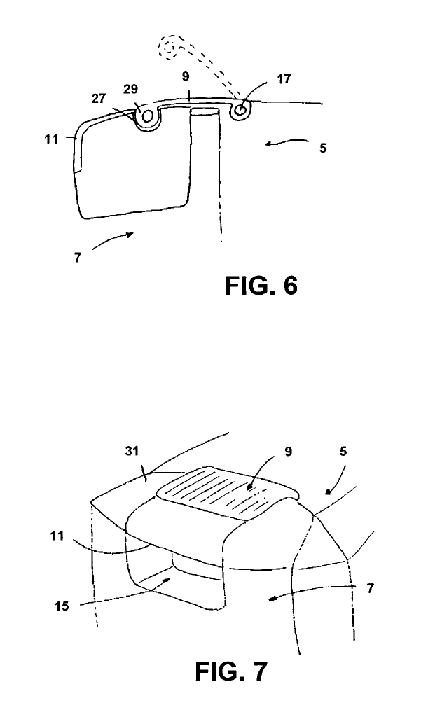

FIGS. 6 and 7 illustrate an alternative embodiment of the present invention, wherein the latch 9 has a circular fastening end 29. The latch 9 is mounted to the housing 5 and pivots around the fulcrum 17 to fasten within a notch 27 formed in the top portion 31 of the bottle 7. As shown in FIG. 7, the depression 15 of the handle 11 remains freely accessible by a user.

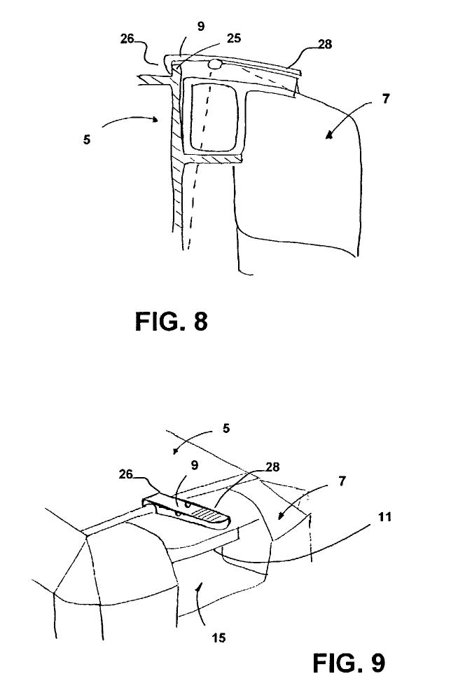

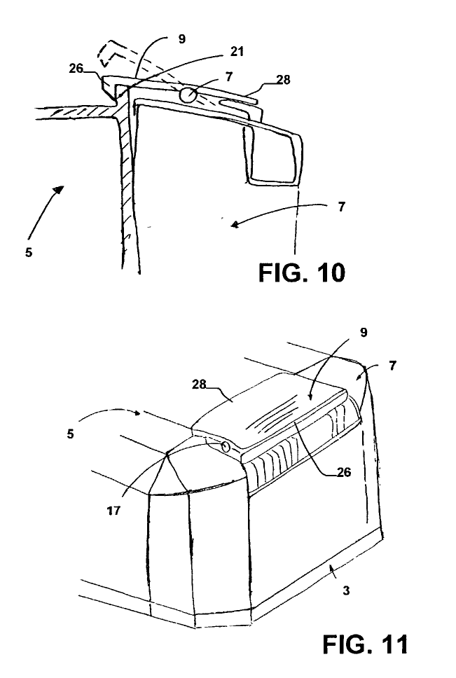

FIGS. 8-11 illustrate alternative embodiments of the humidifier bottle latch wherein the latch 9 is mounted to the bottle 7. The latch 9 is pivotally fastened to the housing 5 and has a latching end 26 and an activation end 28. The latching end 26 of the latch 9 may mate with a raised edge 25 formed in the housing 5. The latch 9 may be biased such that the latching end 26 is normally positioned downwardly as viewed in FIGS. 8-11, in a latched position. In the embodiments illustrated, the activation end 28 is pushed down to lift the latching end 26 such that it clears the edge 25. Again, as shown in FIG. 7, the depression 15 remains freely accessible by a user while the removable housing 5 remains secured to the base 3 by means of the mounted bottle 7. In the version shown in FIGS. 10-11, the latch 9 extents approximately the width of the bottle 7.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular-embodiments disclosed above may be altered or modified and all such variations are considered within the scope and spirit of the invention. Accordingly, the protection sought herein is as set forth in the claims below.

1. A humidifier comprising:
a water reservoir base;
a humidification housing removably positioned on the base, the housing comprising: an upwardly extending sidewall supporting a top portion;
a water bottle for dispensing water into the base, wherein the bottle is situated adjacent the housing and is mounted to the base; and
a latch mounted to one of the housing or the bottle for fastening the housing to the mounted bottle thereby securing the housing to the base by means of the mounted bottle, wherein the latch has a fastened position and an unfastened position.

2. The humidifier of claim 1, wherein the latch is pivotally mounted to one of the water bottle or the housing.

3. The humidifier of claim 1, wherein the bottle further includes a handle situated at an upper end of the bottle.

4. The humidifier of claim 3, wherein the latch is pivotally mounted to the housing, and wherein the latch pivots towards the bottle and resiliently flexes to adjoin with the bottle handle in a fastened position.

5. The humidifier of claim 4, wherein the latch is contiguous with at least a portion of the underside of the bottle handle while in the fastened position.

6. The humidifier of claim 3, wherein the handle is an integrally molded handle formed in the bottle.

7. The humidifier of claim 1, wherein the latch is mounted to the top portion of the humidification housing.

8. The humidifier of claim 1, wherein the latch pivots away from the adjacent water bottle in an unfastened position.

9. The humidifier of claim 2, wherein the handle is an integrally molded handle formed in the bottle.

10. The humidifier of claim 1, wherein the latch is mounted to an upper end of the water bottle.

11. The humidifier of claim 10, wherein the latch comprises a clasp for securing the bottle to the housing.

12. The humidifier of claim 10 wherein the latch pivots away from the adjacent housing in the unfastened position.

13. The humidifier of claim 10, wherein the latch pivots towards the housing to mate with a raised edge formed on the housing.

14. The humidifier of claim 1, wherein the water bottle is removably mounted to the base.

15. The humidifier of claim 14, wherein the water bottle defines a prong extending therefrom arranged to be received by a corresponding tang defined by the base.

16. A humidifier water bottle system for supplying water to a humidifier reservoir contained in a humidifier base, comprising:
a water bottle having upper and lower ends;
the lower end having a connection member for interaction with a corresponding connection member on the base;
the upper end defining a handle therein; and
a latch mounted to the upper end.

17. The humidifier water bottle system of claim 16, wherein the latch is pivotally mounted to the bottle.

18. A method of transporting a humidifier, the humidifier having a humidification housing positioned on a base, the method comprising:
removably mounting a first end of a water bottle to the base adjacent the humidification housing such that water contained in the water bottle is transferable to the base;
latching a second end of the water bottle to the humidification housing; and
lifting the water bottle to lift and transport the humidifier.

19. The method of claim 18, wherein removably mounting the first end of the water bottle includes mating prongs extending from the first end of the water bottle with tangs extending from the base.

20. The method of claim 18, wherein lifting the humidifier bottle includes grasping a handle defined by the humidifier bottle.
